(19) United States
(12) Patent Application Publication
(10) Pub. No.: US 2003/0038710 A1
(43) Pub. Date: Feb. 27, 2003

(54) Frequency management and policing

(76) Inventors: Constantine N. Manis, Monmouth Junction, NJ (US); Oleg Logvinov, East Brunswick, NJ (US); Lawrence F. Durfee, Washington, NJ (US)

Correspondence Address: CHRISTINA HILDEBRAND, NORRIS, MCLAUGHLIN & MARCUS, 220 EAST 42ND STREET - 30TH FLOOR, NEW YORK, NY, 10017, US

(21) Appl. No.: 10/211,031

(22) Filed: Aug. 2, 2002

Related U.S. Application Data
(60) Provisional application No. 60/310,297, filed on Aug. 4, 2001.

(51) Int. Cl. H04M 11/04

(52) U.S. Cl. 340/310.01; 340/310.03

(57) ABSTRACT

A method and system for providing coexistence of power line communication technologies on a common powerline and to communicate with each other. A plurality of devices is provided, each of a different and non-compatible powerline communication technologies. A set of predefined beacon signals for each device is also provides, each signal having a frequency bands. The bands are continuously monitoring for activity. From the activity, necessary changes are derived to accommodation modes to identify devices which may operate outside a norm causing the network of devices to operate incorrectly.

### RELATED APPLICATIONS

The benefit of priority of the provisional application 60/310,297 filed on Aug. 4, 2001 in the names of the inventors, is hereby claimed.

### BACKGROUND OF THE INVENTION

1. Field of the Invention

The present invention relates to powerline communication (PLC) systems for residential, business or other environments to support communications between in-home electronic devices and communications to external destinations such as the Internet. Specifically the invention relates to a method and system that allows different PLC technologies to coexist on a common power line simultaneously.

2. Description of the Related Art

Although the principles of the invention may be used in connection with other communication systems, the invention will be described in connection with the power line communication systems of the type developed by Enikia, LLC. in New Jersey and described at pages 100-107 of the publication entitled “The Essential Guide to Home Networking Technologies” published in 2001 by Prentice-Hall, Inc., Upper Saddle River, N.J., described in copending applications filed Jun. 28, 2000 and entitled Method for Changing Signal Modulation Based on an Analysis of Powerline Conditions and Method for Selecting and Changing Gears in Powerline Networks, the disclosures of the copending applications being incorporated herein by reference.

Numerous powerline communication systems are described in other patents identified in the copending U.S. application Ser. No. 09/290,255.

For several decades, efforts have been made to utilize AC powerlines as communication lines between networks. Powerlines were traditionally reserved to connect a home or business to the electric utility company in order to supply power to the building. Using power lines for communication networks can be extremely advantageous because powerlines are available even in most remote areas, homes and office/business establishments. In addition, most homes and offices are already equipped with multiple electrical power outlets in every room. Thus, doubling up power lines with communication data lines provides enormous economic benefits and makes traditional communication networks, such as phone lines, cable television and computer data network lines obsolete.

However, powerline networks were originally designed for optimal delivery of electricity and not for data signals. The difference is not trivial. Highly variable and unpredictable levels of impedance, signal attenuation, noise and, generally, radiated emission may create an extremely harsh environment that makes data transmission over power lines challenging.

The object of the present invention is to provide a scheme that allows different PLC technologies to coexist on the powerline simultaneously and thus give the user an even wider choice of products to use.

### SUMMARY OF THE INVENTION

The objective of the invention is to allow multiple, non-compatible PLC technologies to coexist and communicate with like devices on the same powerline network with minimal interference and with just a few changes to the existing technology.

The concept involves the use of a set of predefined beacons, one set for each competing PLC technology which uniquely defines when a device of that technology is transmitting. The beacons may be activated only while the device is transmitting and are off otherwise. Other devices, of differing technologies, have the capability of detecting, i.e., listen for these tones (beacons) and use them to determine the need to go into accommodation mode by altering the transmission characteristics of the devices to accommodate different PLC technology on the same powerline network, and, based on which beacon is present, select an accommodate mode.

Another key part of this invention is to use data (e.g., signal magnitude, tone frequency, etc.) gathered by the listening process to evaluate and report to higher level processes, out-of-tolerance transmissions (e.g., excess signal strength, out of specification tone frequency, etc.).

Other objects and features of the present invention will become apparent from the following detailed description considered in conjunction with the accompanying drawings. It is to be understood, however, that the drawings are intended solely for purposes of illustration and not as a definition of the limits of the invention, for which reference should be made to the appended claims.

### BRIEF DESCRIPTION OF THE DRAWINGS

In the drawings, wherein like reference numerals delineate similar elements throughout the several views:

FIG. 1 illustrates an overview of a typical single home installation of several PLC devices, with different technologies;

FIG. 2 illustrates a home installation in which the home has both in-home PLC and access PLC services;

FIG. 3 illustrates an example of spectrum overlap between in-home PLC and access PLC;

FIG. 4 illustrates the TDM with beacon concepts by showing examples of slots and frequency allocations for several different PLC technologies with information from beacons used to coordinate access to the powerline medium;

FIG. 5 illustrates an example of accommodation by moving spectral segments;

FIG. 6 illustrates examples of beacon generator and receiver elements.

### DETAILED DESCRIPTION OF THE PRESENTLY PREFERRED EMBODIMENTS

For purposes of definition of terminology, the Technical Specification published by ETSI TS 101 867 V 1.1.1 (2000-11), entitled “Powerline Telecommunications (PLT), Coexistence of Access and In-House Powerline Systems” is hereby incorporated by reference.

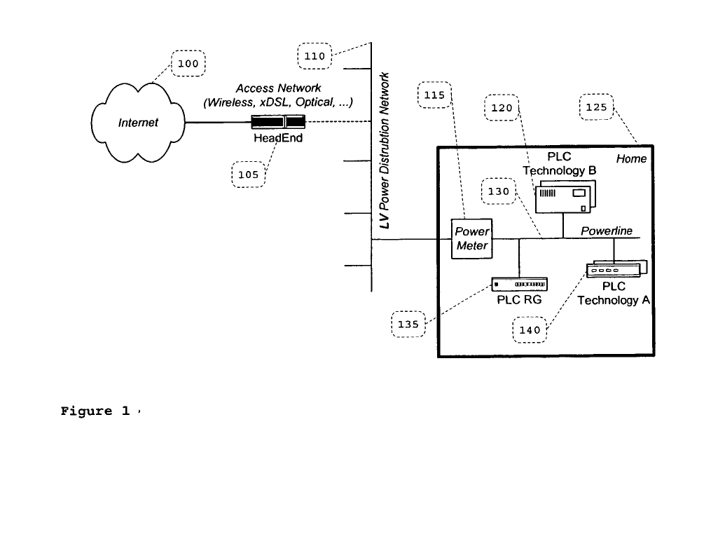

FIG. 1 shows a typical single home installation of several PLC devices, with different technologies. As shown, for each technology, at least two devices communicate with each other. A residential gateway in-home device 135, PLC RG, connects the in-home network to the Internet 100 via a Head End 105 through a low voltage (LV) power distribution network 110, using PLC access technology. The other in-home devices communicate with other in-home devices of the same technology. The power meter 115 attenuates the signal coming in from the LV network.

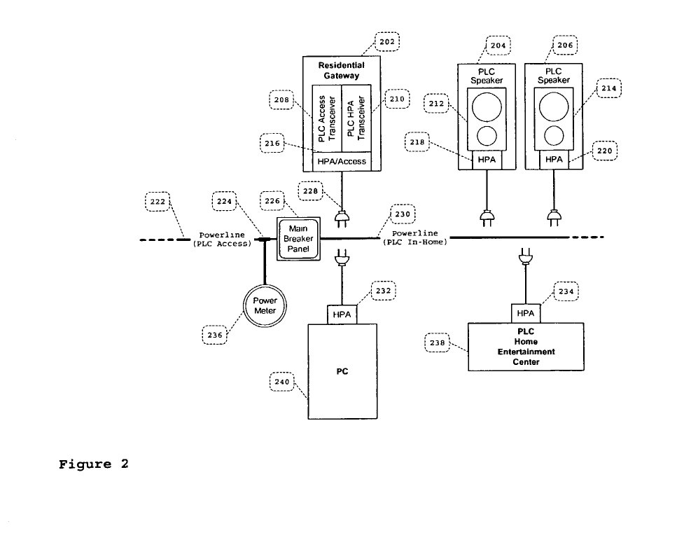

FIG. 2 shows a typical in-home installation in which both, an in-home PLC service and an access PLC service are provided. The residential gateway 202, including a HPA Access 216 and a PLC Access Transceiver 208 and a PLC HPA Transceiver 210, acts as a bridge between access and in-home PLC links. The PLC Access 222 powerline connects at 234 to a power meter 236 and a main breaker panel 226 to the PLC In-home powerline 230. As is shown, four PLC applications 204, 206, 238 and 240 readily connect to the PLC In-Home powerline. Application 204 and 206 are a pair of PLC speakers 212 and 214, each with an HPA 218 and 220 and application 234 is a PLC Entertainment Center 238 connected to a HPA 234 and application 240 is a PC connected to a HPA 232.

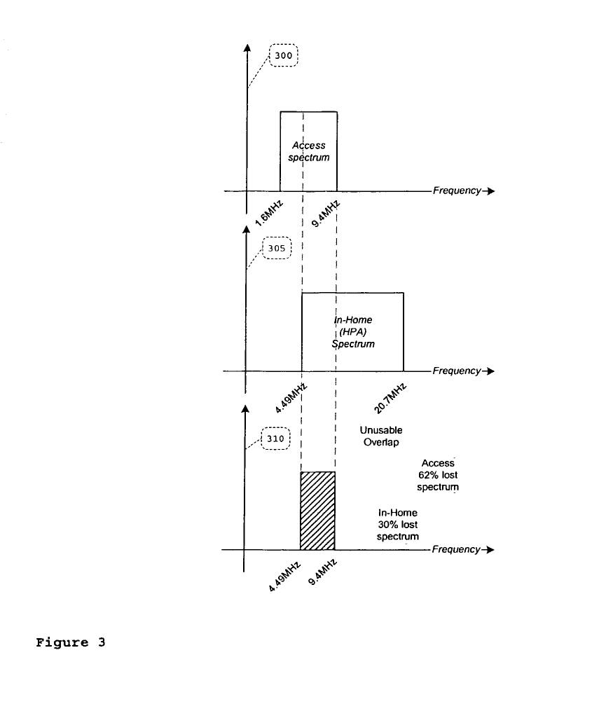

FIG. 3 provides an example of spectrum overlap between in-home PLC and access PLC. The access devices 300, as shown, operate with an access spectrum between about 1.6 MHz and 9.4 MHz, while the in-home devices 305 operate between about 4.49 MHz and 9.4 MHz. The overlapping spectrum 310, where both devices interfere with each other, is about 4.49 MHz to 9.4 MHz. Accordingly, for the access spectrum, there is a loss of about 62% of the spectrum and for the In-Home (HPA) spectrum; the loss is about a 30% loss of the spectrum.

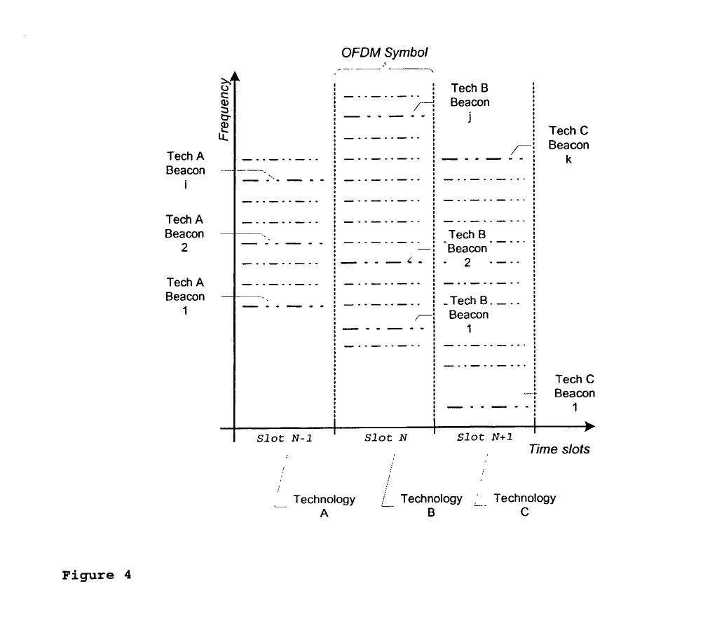

FIG. 4 shows examples of three technologies, technology A, technology B and technology C, each having an associated respective beacon 1, 2 and 3. The time slots, slot N−1, Slot N and slot N+1 and frequency allocations for each different PLC technologies with information from beacons, as explained below, is used to coordinate access to the powerline medium. The three time slots are allocated for different technologies to communicate with like devices during that time slot. Pre-assigned beacons, different assignments for different technologies, are allocated at multiple fixed frequencies.

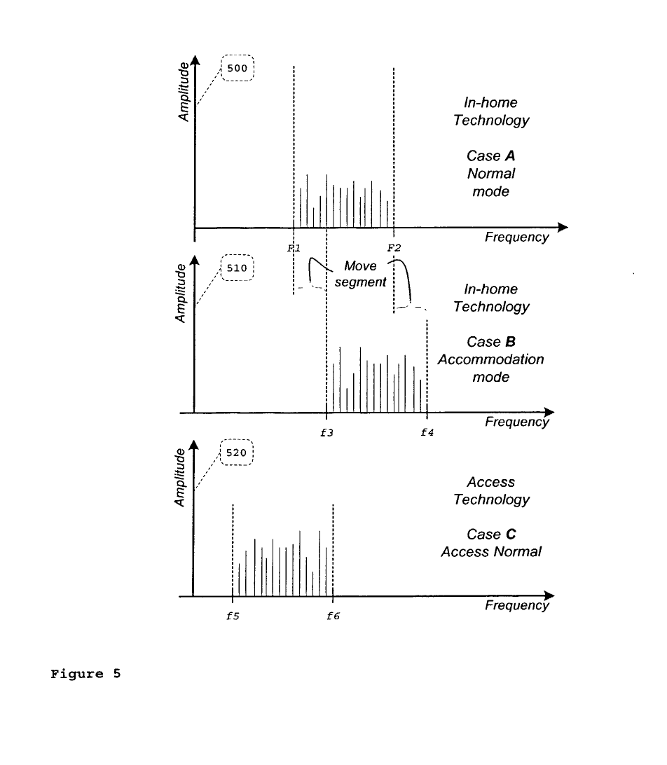

FIG. 5 illustrates an example of the concept of altering transmission characteristics to accommodate for coexistence. Here, an amplitude 500 of a normal spectrum for in-home technology is shown as case A, at a frequency between f1 and f2 while the normal spectrum 520 content for an access technology is shown in case C, at a frequency between f5 and f6. The in-home devices accommodate the access spectrum by translating a spectrum section to a high frequency as shown in case B, 510, between f3 and f4.

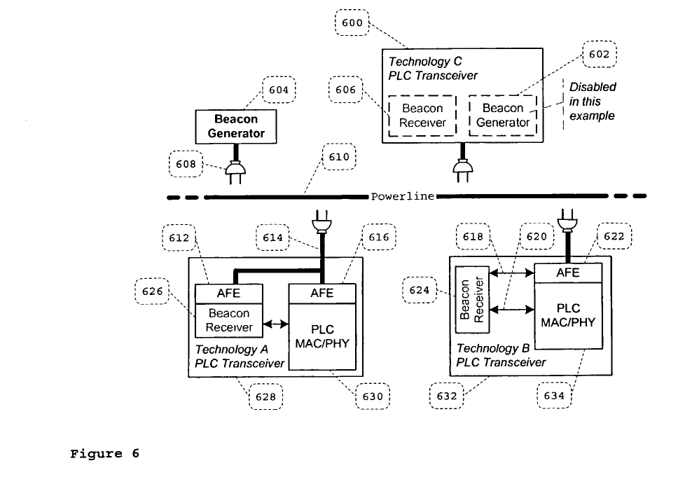

FIG. 6 shows a few of many ways to implement the beacon generator and receiver elements. There are four possibilities depicted: beacon generator 604 packaged separately, beacon generator packaged within a product 628, beacon generator within a product 632 and sharing components (in this case, the AFE 622) and a beacon generator fully integrated into a device 600 where many features are shared.

1. Beacons

Each set of multiple beacon signals (one set for each PLC technology) are established with one simple standard set of communications parameters, such as frequencies, technology slot assignments, robust modulation technique and data format, to be used by all competing devices. The selection of these parameters is driven by the need to reduce the impact of the additional functionality on the technologies involved. For example, the frequencies chosen will be ones that already exist for that technology (i.e., in-band beacons).

Multiple beacons, for each technology, are needed because of a characteristic of the powerline medium to attenuate signals selectively, by frequency, along the length of the network. This attenuation changes as loads are switched in and out, as well as when noise sources (e.g., mostly caused by appliances such as hair dryers, vacuum cleaners, blenders etc.), which will also block certain frequency bands, are switched on and off. Multiple beacons will insure that every receiver on a given powerline network will have at least one beacon to use.

Different beacons are needed for each technology so that devices that necessitate accommodation, can determine which mode to use when they sense a beacon. Furthermore, the parameters for policing will change depending on which technology is used and this will be determined once a beacon is detected.

Since devices, containing beacon sources, can be switched on and off at any time, the accommodation mode can be switch back to normal as needed. That is, when no beacon activity is sensed, devices can revert to their normal mode of operation to regain communications bandwidth.

2. Monitoring of Selected Frequency Bands

Each technology has a particular set of beacon frequency bands assigned to it. These bands are continuously monitored by all network PLC transceivers, of all PLC technologies, for activity. The presence or absence of these beacon signals indicates the need to change to a particular accommodation mode. In addition to simply monitoring for these signals, other parameters are gathered to allow policing. If the signal amplitude is measured, it is compared against a standard value and out-of-range reports could be submitted. Other possible parameters include channel occupancy width, frequency deviation and others. Any or all of these could be reported to higher-level entities based on pre-established policies. This gathered diagnostic information may be used to identify which device or devices are operating outside of norms and potentially causing the entire network of devices to operate incorrectly. It is important for consumers to know why their network is not working properly and what to do to reestablish proper operation.

3. Modes of Accommodation

One possible method to accommodate other technologies is to move frequency content to another part of the spectrum. As shown in FIG. 5, where two modes of operation are shown, a normal mode in case A, 500, and case C, 520, and accommodation mode, case B, 510. When beacon information dictates a switch to accommodation mode, the unit moves, in a coordinated fashion with other like devices, a segment of the frequency out of the interfering band and into a higher, non-interfering band of frequencies. This allows both technologies to have complete bandwidth within which to operate.

4. Coexistence Mechanisms

One mechanism to allow coexistence of multiple incompatible PLC technologies is to use a TDM scheme. That is, a time slot is assigned to each technology, which can communicate with other like devices during that time slot. The time slot is pre-determined as is the set of beacons used to broadcasts its existence on the network. The beacons would be use for time slot timing, sequencing and other features.

Thus, while there have been shown and described and pointed out fundamental novel features of the invention as applied to a preferred embodiment thereof, it will be understood that various omissions and substitutions and changes in the form and details of the devices illustrated, and in their operation, may be made by those skilled in the art without departing from the spirit of the invention. For example, it is expressly intended that all combinations of those elements and/or method steps, which perform substantially the same function in substantially the same way to achieve the same results, are within the scope of the invention. Substitutions of elements from one described embodiment to another are also fully intended and contemplated. It is also to be understood that the drawings are not necessarily drawn to scale but that they are merely conceptual in nature. It is the intention, therefore, to be limited only as indicated by the scope of the claims appended hereto.

What is claimed is:

1. A method for providing coexistence of power line communication technologies on a common powerline, the method comprising the steps of
providing a plurality of devices, each being of a different and non-compatible powerline communication technologies;
providing a set of predefined beacon signals for each device, having frequency bands; continuously monitoring the frequency bands for activity;
determining from the activity necessary changes to accommodation modes to identify devices which may operate outside a norm causing the network of devices to opiate incorrectly.

2. The method for providing coexistence of power line communication technologies according to claim 1, wherein the monitoring step includes measuring signal amplitude of the bands.

3. The method for providing coexistence of power line communication technologies according to claim 2, further comprising the step of comparing the signal amplitude against a standard amplitude value.

4. The method for providing coexistence of power line communication technologies according to claim 2, wherein the monitoring step includes measuring a channel occupancy width.

5. The method for providing coexistence of power line communication technologies according to claim 2, wherein the monitoring step includes measuring a frequency deviation.

6. A method for accommodating coexistence of different power line communication technologies on a common powerline and to communicate with each other, the method comprising the steps of
providing a plurality of devices, each being of a different and non-compatible powerline communication technologies;
providing a set of predefined beacon signals for each device, having frequency bands;
moving the frequency content to another part of the frequency spectrum.

7. A system for providing coexistence of power line communication technologies on a common powerline and to communicate with each other, comprising
a plurality of devices, each being of a different and non-compatible powerline communication technologies, each device having a set of defined beacon signals having defined frequency bands;
a monitor for monitoring the frequency bands for activity to determine changes to accommodation modes to identify devices which may operate outside a norm causing the network of devices to operate incorrectly.

8. The system for providing coexistence of power line communication technologies on a common powerline and to communicate with each other as claimed in claim 7, including multiple TDM slots to accommodate the coexistence of different incompatible technologies on the same network.
